(19) United States
(12) Patent Application Publication
(10) Pub. No.: US 2016/0335608 A1
(43) Pub. Date: Nov. 17, 2016

(54) Virtual Payment Device Including a Scannable Code

(71) Applicant: Bank of America Corporation, Charlotte, NC (US)

(72) Inventors: Tamilarasan Balasubramani, Bellevue, WA (US); Manoj Shankar, Seattle, WA (US); Raghav Shenoy, Charlotte, NC (US)

(21) Appl. No.: 14/713,548

(22) Filed: May 15, 2015

(51) Int. Cl. G06Q 20/06; G06Q 20/32; G06Q 20/10

(52) U.S. Cl. CPC G06Q 20/065; G06Q 20/102; G06Q 20/322

(57) ABSTRACT

Systems, methods, apparatuses, and computer-readable media configured to generate a virtual payment device having a scannable code are presented. The scannable code may be a bar code, quick response code, or, in some examples, the virtual payment device may include both. In some arrangements, a user may provide one or more parameters associated with the virtual payment device, such as an amount, an expiration date, and/or a name of one or more merchants at which the virtual payment device may be used. The virtual payment device may be generated and the scannable code may include the parameter information. Accordingly, a user may scan the code on the virtual payment device at a point of sale system at a merchant to use the virtual payment device as a method of payment. If the virtual payment device is authenticated, the transaction may be processed by the point of sale system.

### BACKGROUND

Customers are often looking for efficient and secure methods of conducting transactions, such as making purchases, paying bills, and the like. While customers often use a debit card for such transactions, if a user's debit card is lost or stolen, the card may be used for unauthorized purchases at almost any merchant. Further, loss of the debit card may require a user to obtain a new card with a new number, and the like. Accordingly, a payment device having secure, unique payment information would be advantageous.

### SUMMARY

Aspects of the disclosure relate to various systems, methods, apparatuses, and computer-readable media configured to generate a virtual payment device having a scannable code. The scannable code may be a bar code, quick response code, or, in some examples, the virtual payment device may include both. In some arrangements, a user may provide one or more parameters associated with the virtual payment device, such as an amount, an expiration date, and/or a name of one or more merchants at which the virtual payment device may be used.

The virtual payment device may be generated and the scannable code may include the parameter information. Accordingly, a user may scan the code on the virtual payment device at a point of sale system at a merchant to use the virtual payment device as a method of payment. If the virtual payment device is authenticated, the transaction may be processed by the point of sale system.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an illustrative operating environment in which various aspects of the disclosure may be implemented in accordance with one or more aspects discussed herein;

FIG. 2 depicts an illustrative block diagram of workstations and servers that may be used to implement the processes and functions of certain aspects of the present disclosure in accordance with one or more aspects discussed herein;

FIG. 3 illustrates one example virtual payment device generation and processing system in accordance with one or more aspects discussed herein;

FIGS. 4A and 4B illustrate one example event sequence for generating a virtual payment device in accordance with one or more aspects described herein;

FIGS. 5A and 5B illustrate one example event sequence for processing a transaction using a virtual payment device in accordance with one or more aspects discussed herein;

FIG. 6 illustrates one example method of generating a virtual payment device according to one or more aspects described herein;

FIG. 7 illustrates one example method of using a virtual payment device during a transaction according to one or more aspects described herein;

FIG. 8 illustrates one example user interface for inputting one or more virtual payment device parameters in accordance with one or more aspects discussed herein;

FIG. 9 illustrates one example user interface displaying a virtual payment device including a code, such as a bar code or QR code, in accordance with one or more aspects discussed herein; and

FIG. 10 illustrates one example user interface listing available virtual payment devices associated with a user in accordance with one or more aspects discussed herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Aspects of this disclosure relate to generating a virtual payment device having a scannable code, such as a bar code or quick response (QR) code, and using the virtual payment device to complete a transaction (e.g., make a purchase, or the like). When generated, the virtual payment device may be transmitted to a user (e.g., to a computing device of the user) and the user may then scan the scannable code at a point of sale system at a merchant. The transaction may then be processed. In some examples, a user may set one or more parameters associated with the virtual payment device, such as an amount, expiration date, and one or more particular merchants at which the virtual payment device may be used (e.g., in some examples, the virtual payment device may be used at only the merchants identified). These and other features will be described more fully below.

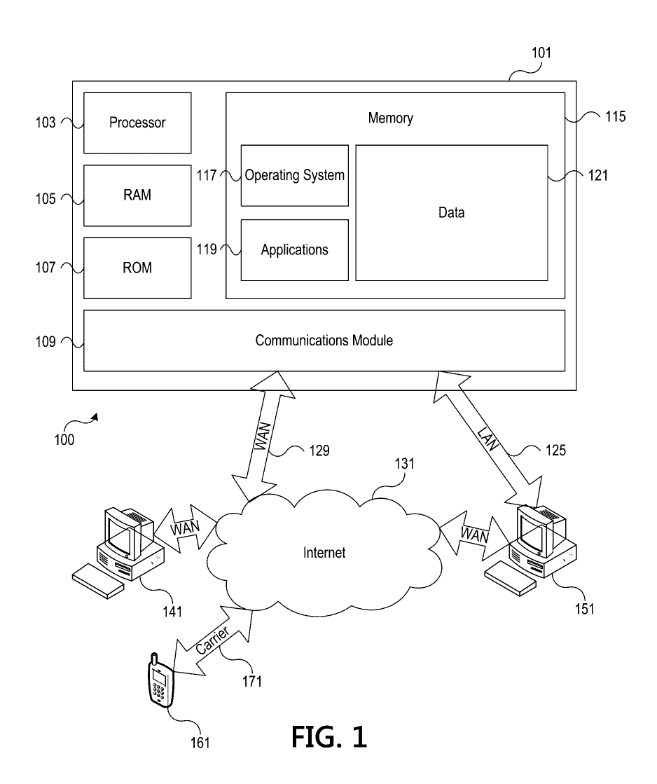

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141, 151, and 161. Computing devices 141, 151, and 161 may be personal computing devices or servers that include any or all of the elements described above relative to computing device 101. Computing device 161 may be a mobile device (e.g., smart phone) communicating over wireless carrier channel 171.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like. In some examples, these known computing systems may be configured (e.g., with particular hardware, software, or combinations thereof) to perform the functions described herein. For instance, general purpose computing devices may be configured with particular hardware and/or software to perform the functions described herein (e.g., authenticating a user, identifying a user account, generating a virtual payment device, processing a transaction using the virtual payment device, and the like). In other examples, the computing device may be a special purpose computing device having particular components that are configured to perform the functions described herein.

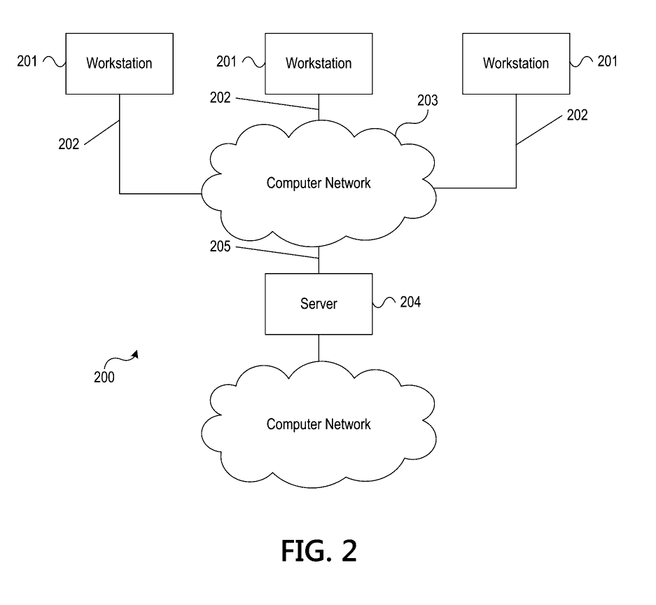

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like, that is configured to perform the particular functions described herein. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, as well as network types developed in the future, and the like.

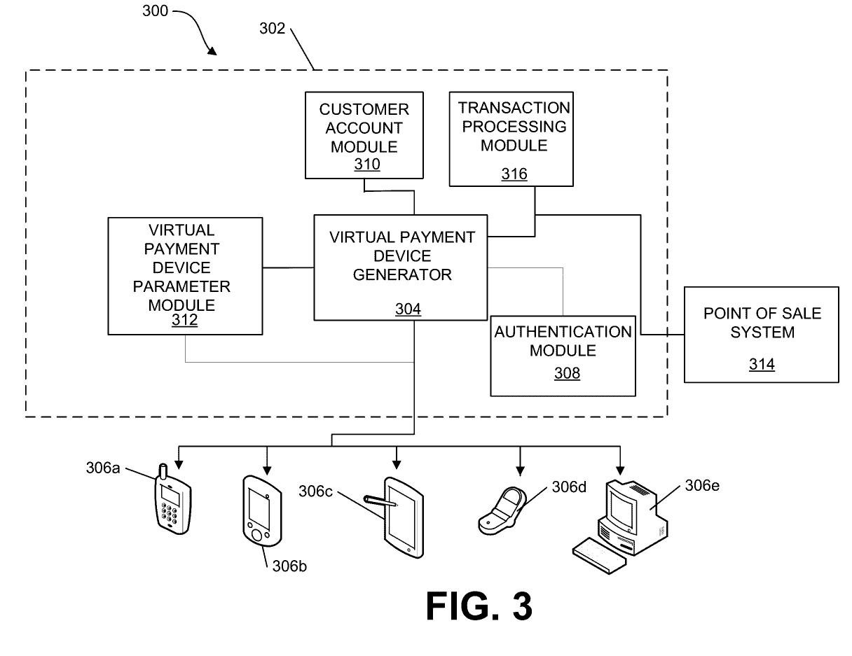

FIG. 3 illustrates one example virtual payment device generation and processing system. In some examples, the virtual payment device generation and processing system 300 may be part of, internal to, or associated with an entity 302. The entity 302 may be a corporation, university, government entity, or the like. In some examples, the entity 302 may be a financial institution, such as a bank. Although various aspects of the disclosure may be described in the context of a financial institution, nothing in the disclosure shall be construed as limiting the virtual payment device generation and processing system 300 to use within a financial institution. Rather the system may be implemented by various other types of entities.

Further, aspects of the virtual payment device generation and processing system 300 may be contained in one or more computing devices, servers, or the like configured to perform the particular functions described herein. For instance, the virtual payment device generation and processing system 300 may include one or more modules, devices, systems, or the like, that may be implemented in hardware and/or software configured to perform various functions (e.g., functions particular to the virtual payment device generation and processing system 300) within the system 300. One or more modules may be contained within the same physical device or may be housed in separate devices. Further, although one or more modules shown in FIG. 3 are within the entity 302, any of the modules may be located external to the entity 302 but may be associated with the entity 302. For instance, one or more modules may be associated with a personal computing device of a user. Accordingly, various functionality associated with the modules may be performed at the personal computing device, which may be located external the entity 302 but may be associated with the entity by way of a user associated with the device being associated with the entity 302 (e.g., a customer of the entity), the device including or running an application of the entity 302, and the like. Nothing in the disclosure should be viewed as limiting the one or more modules to a same physical location or a location within an entity.

Virtual payment device generation and processing system 300 may include a virtual device payment generator module 304, which may include a back end server. The virtual payment device generator module 304 may be in communication with one or more computing devices, such as computing devices 306a-306e. For instance, the computing devices may include a smart phone 306a, personal digital assistant 306b, tablet computing device 306c, cell phone 306d, or other type of computing device 306e. In some examples, a user may request generation of a virtual payment device via one or more of the computing devices 306. The request may be transmitted to the virtual payment device generator module 304.

Upon receiving the request to generate the virtual payment device, a request for authentication may be transmitted to an authentication module 308. The authentication module 308 may store user authentication information and may compare received information to the stored information to determine whether the request to generate the virtual payment device is authorized. For instance, the authentication module 308 may store information such as a username and password, biometric data (e.g., fingerprint, or the like), or the like. Upon receiving the request to generate a virtual payment device, the authentication module 308 may request authentication information from the user. The user may input the authentication information (e.g., username and password, biometric data, and the like) via one or more of the computing devices 306 and the authentication module 308 may compare the received information to the stored information. If there is a match, the request to generate the virtual payment device is authenticated and may proceed. If there is no match, the request may be denied or a request for additional authentication information may be transmitted to the user.

The virtual payment device generation and processing system may further include a customer account module 310. The customer account module 310 may be one or more databases and may include information associated with various users, such as name, contact information, and the like. In addition, the customer account module 310 may include information associated with one or more accounts of the user. The accounts may include check accounts, savings accounts, lines of credit, credit card accounts, and the like. Accordingly, upon determining that the request for a virtual payment device is authorized, the system may identify the customer (e.g., based on authentication information) and may identify one or more accounts from which the virtual payment device may be drawn (e.g., from which a balance to place on the virtual payment device may be withdrawn). In some examples, the available accounts may be transmitted to the user (e.g., to one or more computing device 306) for selection of the account. In other examples, the user may designate (or the system may determine) that one account should be the default account for use in generating the virtual payment device and the system may automatically deduct the balance from the default account. An amount of the virtual payment device may then be deducted from the selected (or default account) either upon generation of the virtual payment device or upon use of the device.

The virtual payment device generation and processing system 300 may further include a virtual payment device parameter module 312. The virtual payment device parameter module 312 may request one or more parameters associated with the requested virtual payment device. For instance, the virtual payment device parameter module 312 may request user input identifying an amount of the virtual payment device, an expiration date of the virtual payment device, a merchant at which the virtual payment device may be used, and the like. Accordingly, the user may provide these parameters as limits on how, when, where, and the like, the virtual payment device may be used. Once the parameters are received, they may be transmitted to the virtual payment device generator module 304 and the virtual payment device may be generated.

In some arrangements, generating the virtual payment device may include mapping the virtual payment device to the selected (or default) user account. Accordingly, transactions performed using the virtual payment device may cause an amount of the transaction, or an amount of the virtual payment device to be deducted from the user account. In some examples, such as when the virtual payment device is used as a debit card, the amount may be deducted from the user account upon use of the virtual payment device. In other examples, such as when the virtual payment device is used as, for instance, a virtual gift card, the amount of the virtual payment device may be deducted from the user account upon generating the virtual payment device.

In some examples, the generating the virtual payment device may include generating a bar code and/or a quick response (QR) code. The code (e.g., bar code or QR code) may include data associated with the virtual payment device such that, a user may scan the code on the virtual payment device (e.g., from the computing device 306 of the user) at a point of sale system (e.g., a point of sale system at a merchant) in order to use the virtual payment device for payment in a transaction. For example, the virtual payment device generator module 304 may generate a virtual payment device having a bar code. The user may scan the bar code at, for example, point of sale system 314 and the system may determine, from the bar code, the amount of the virtual payment device, an account from which funds should be debited, an expiration date of the virtual payment device (if any) and/or a merchant at which the virtual payment device may be used. The scannable code (e.g., bar code, QR code, or the like) may be mapped to the account selected for use in generating the virtual payment device (e.g., by account number, routing number, and the like).

In some arrangements, both a bar code and QR code may be generated for the virtual payment device. Accordingly, a display or user interface displaying the virtual payment device and a first type of code (e.g., one of a bar code or QR code) may include an option to display the second type of code (e.g., the other of the bar code or QR code) in order to provide greater flexibility for use of the virtual payment device at different types of point of sale systems.

Scanning the code on the virtual payment device at a point of sale system (e.g., point of sale system 314) may prompt the system to process the transaction, e.g., via transaction processing module 316. The transaction processing module 316 may authenticate the transaction (e.g., determine whether the virtual payment device is active (e.g., not expired), confirm that the merchant from which the request was received is a merchant for which the virtual payment device is authorized, and the like). If the requested transaction meets the parameters of the virtual payment device, the transaction may be authorized and the amount associated with the transaction may be deducted from a balance of the virtual payment device. If not, the transaction may be denied and a notification of the denial may be transmitted to the user (e.g., to the computing device 306 of the user).

If a balance is remaining on the virtual payment device, the virtual payment device may continue to be stored until the entire balance has been used, or until the identified expiration date of the virtual payment device. If there is no remaining balance, the system may delete the virtual payment device.

These and other arrangements will be discussed more fully below.

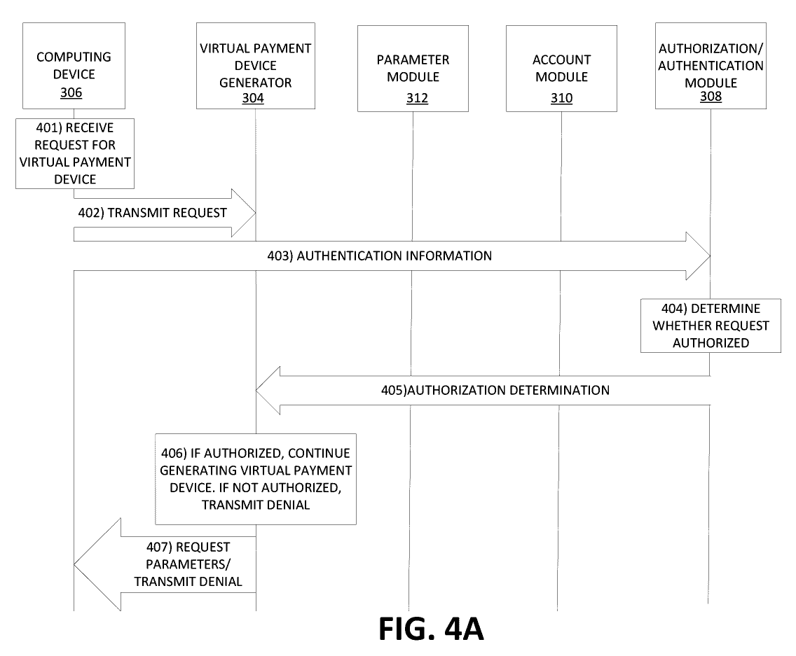

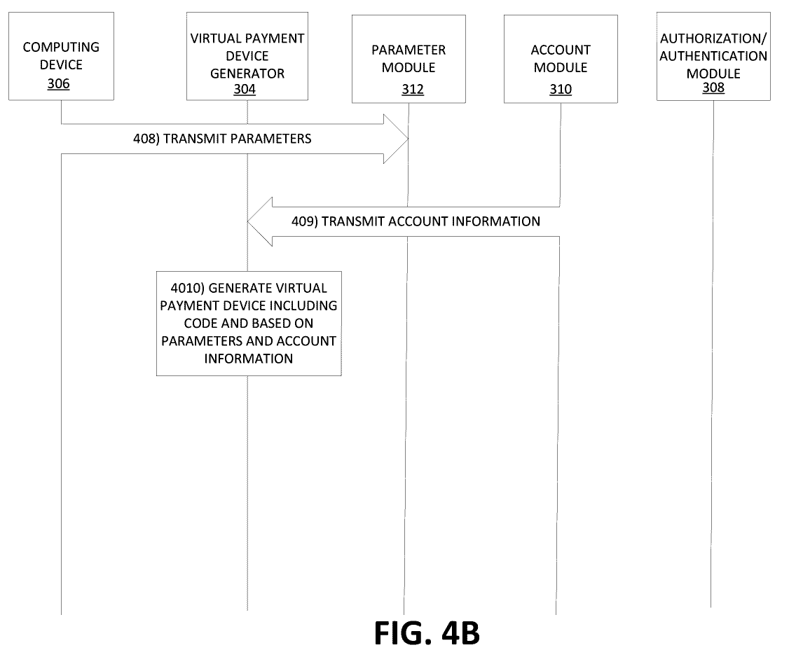

FIGS. 4A and 4B illustrate one example event sequence for utilizing the virtual payment device generation and processing system 300 to generate a virtual payment device in accordance with one or more aspects described herein. The example shown in FIGS. 4A and 4B is merely one example sequence and various other steps, processes, or the like, may be included in a sequence without departing from the invention.

With reference to FIG. 4A, in step 401, a request for a virtual payment device may be received. For instance, a user may input a request to generate a virtual payment device to a computing device 306. In step 402, the request may be transmitted from the computing device 306 to the virtual payment device generator module 304. The virtual payment device generator module 304 may initiate generation of the virtual payment device and may be in communication with the authentication/authorization module 308. A request for authentication information may be transmitted to the computing device and in step 403, the authentication information may be received by the authentication/authorization module 308. In step 404, a determination may be made as to whether the virtual payment device request is authorized. As discussed herein, authorization/authentication information may include a username and password, biometric data, and the like.

In step 405, the authorization determination may be transmitted to the virtual payment device generator 304. If the request is authorized, the virtual payment device generator 304 may continue the process of generating the virtual payment device in step 406. If not, a denial of the request may be generated in step 406. The denial may be transmitted to the computing device in step 407. Alternatively, if the request is authorized, a request for parameters associated with the virtual payment device may be transmitted to the computing device 306 in step 407.

In step 408 in FIG. 4B, one or more parameters associated with the virtual payment device may be received from the user by the computing device 306 and transmitted to the parameter module 312. The parameters may include an amount of the virtual payment device, an expiration date of the virtual payment device (if any) and/or identification of one or more merchants at which the device may be used.

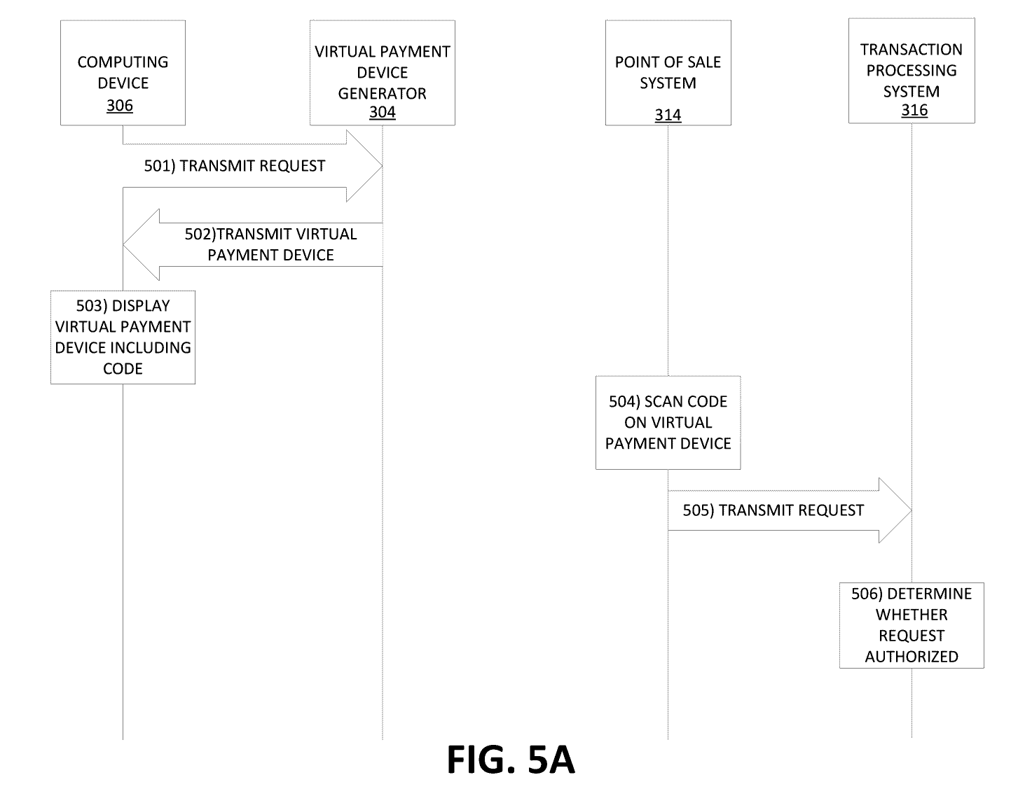

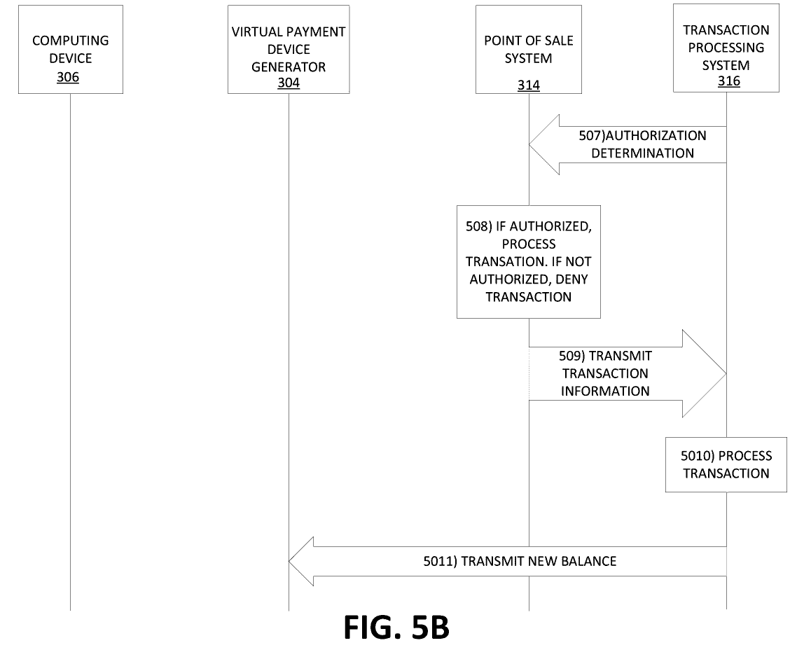

In step 409, an account associated with the user may be identified and transmitted to the virtual payment device generator 304. The account may, as discussed herein, be selected by a user or may be a default account identified by the user or the system automatically. In step 4010, the virtual payment device may be generated based on the received account information and the parameters received from the user. Generating the virtual payment device includes generating one or both of a bar code and QR code storing the information needed to process a transaction using the virtual payment device. Accordingly, by scanning the code, a transaction may be processed, as shown in FIG. 5. Generating the virtual payment device may include displaying the virtual payment device on the user computing device 306. In some arrangements, the virtual payment device may be transmitted to a user via email, SMS, or other communication system. In such arrangements, the virtual payment device may be transmitted directly or the message may include a link or other option that may be selected by a user when the user desires to view or use the virtual payment device.

FIGS. 5A and 5B illustrate one example event sequence for utilizing the virtual payment device generation and processing system 300 to process a transaction using a virtual payment device in accordance with one or more aspects described herein. The example shown in FIGS. 5A and 5B is merely one example sequence and various other steps, processes, or the like, may be included in a sequence without departing from the invention.

Referring to FIG. 5A, in step 501, a request to display a virtual payment device that was previously generated may be transmitted from a user computing device to the virtual payment device generator 304. In some examples, the request may be made by selecting a link in an email message received from the system 300. In step 502, the virtual payment device may be transmitted to the user computing device 306 and the virtual payment device, including the bar code and/or QR code may be displayed on the computing device 306 in step 503.

In step 504, a user may attempt to use the virtual payment device during a transaction by scanning the bar code or QR code at a point of sale system at a merchant. In step 505, scanning the bar code or QR code may cause the system to transmit a request to process the transaction to a transaction processing system 316. In step 506, the transaction processing system 316 may determine whether the transaction is authorized (e.g., whether the virtual payment device is authorized for use at that merchant, whether the virtual payment device is still active or has expired, and the like).

With reference to FIG. 5B, in step 507, the results of the authorization determination may be transmitted to the point of sale system. For instance, if the transaction is not authorized (e.g., because the virtual payment device has expired, or the like) then the transaction may be denied and the point of sale system will be notified and the transaction will not be completed in step 508. Alternatively, if the transaction is authorized, the transaction may be processed by the point of sale system in step 508.

In step 509, transaction information may be transmitted to the transaction processing system 316. Accordingly, the transaction may be processed by the transaction processing system 316 in step 5010. For instance, an amount of the transaction may be deducted from the balance of the virtual payment device. Any remaining balance may be transmitted back to the virtual payment device generator 304 in step 5011 and stored for further use.

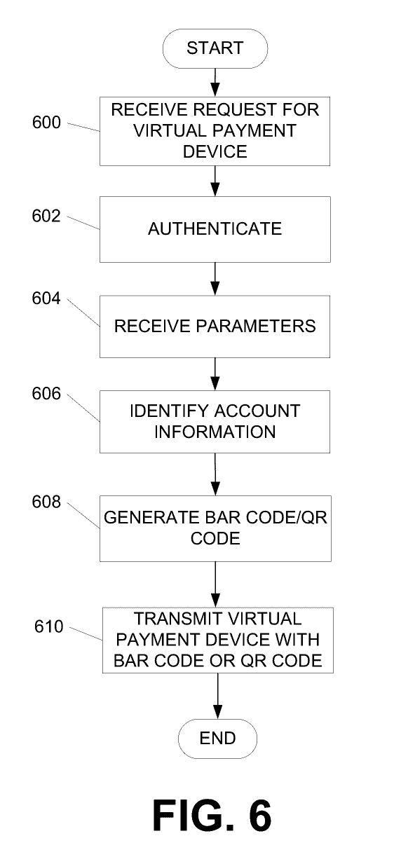

FIG. 6 illustrates one example method of generating a virtual payment device according to one or more aspects described herein. In step 600, a request to generate a virtual payment device may be received. In some examples, the request may be received at a time when the user would like to use the virtual payment device in a transaction. Accordingly, the virtual payment device may be generated in real-time (or near real-time) upon receiving the request.

In step 602, the request to generate the virtual payment device may be authenticated. Accordingly, the system may request authentication information from the user and match the received authentication information to pre-stored authentication information (e.g., username and password, biometric data such as a fingerprint, or the like). If the authentication information does not match, the request to generate the virtual payment device may be denied.

In step 604, once the request is authenticated, parameters associated with the virtual payment device may be received. As discussed herein, the parameters may include an amount of the virtual payment device, any expiration date, identification of one or more merchants at which the virtual payment device may be redeemed, and the like. In step 606, account information from which the amount of the virtual payment device should be withdrawn may be identified. As discussed herein, the account may be a default account automatically selected by the system. For instance, the system may automatically identify a checking account of a user as the account from which to deduct the amount of the virtual payment device. In another example, the account may be selected by a user. For instance, the system may identify a plurality of accounts associated with the user and the user may select a desired account from the identified plurality of accounts. In another example, a user may select one account from the plurality of accounts associated with the user as the default account and the system may automatically use that account based on selection by the user.

In step 608, the virtual payment device may be generated and include a bar code and/or QR code that may be scanned by a point of sale system. As discussed herein, the bar code and/or QR code may include information associated with the virtual payment device, such as an amount, expiration date, identity of merchants at which the virtual payment device may be used, and the like. In some arrangements, accessing the virtual payment device may automatically include display of one of the bar code or QR code. The virtual payment device may include an option to display the other of the bar code or QR code, as desired by the user, to provide flexibility for use with various types of point of sale systems.

In step 610, the virtual payment device and associated bar code/QR code may be transmitted to, for instance, a user computing device. In some examples, the virtual payment device may be transmitted directly to the user computing device (e.g., the virtual payment device itself may appear on the computing device of the user with the bar code/QR code). Additionally or alternatively, the virtual payment device including the bar code/QR code may be transmitted to an email address of the user. The virtual payment device itself may be transmitted or a link that may be selected to display the virtual payment device may be transmitted to the user. This option may provide the user with the ability to send the virtual payment device to another individual (e.g., as a gift) by forwarding the message (e.g., email) with the virtual payment device or link to the virtual payment device.

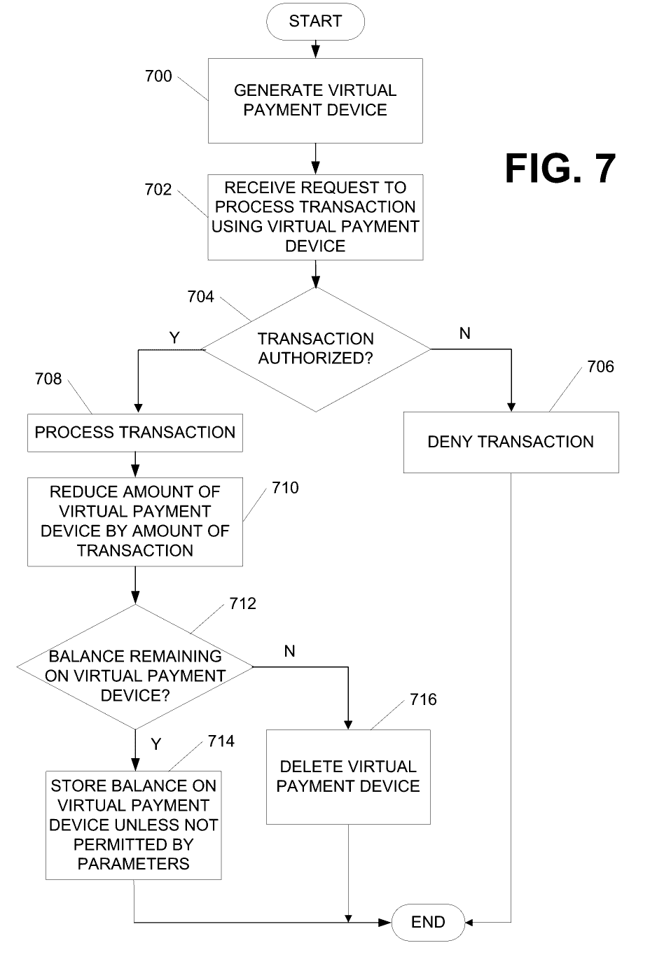

FIG. 7 illustrates one example method of using a virtual payment device during a transaction according to one or more aspects described herein. In step 700, a virtual payment device may be generated. Generating the virtual payment device may be performed according to one or more aspects described herein. The virtual payment device may be generated in real-time (e.g., while at the point of sale system and desiring to use the virtual payment device during the transaction) or in advance and may be displayed when requested by the user.

In step 702, a bar code or QR code on the virtual payment device may be scanned at a point of sale system and may initiate a request to process a transaction using the virtual payment device. In step 704, a determination is made as to whether the transaction is authorized. As discussed herein, determining whether the transaction is authorized may include determining whether the virtual payment device has expired, is authorized for use at the particular merchant, or the like. If the transaction is not authorized, the transaction may be denied in step 706 and the process may end.

If, in step 704 the transaction is authorized, the transaction may be processed in step 708. That is, the merchant may process the sale or other transaction at the point of sale system using the virtual payment device. In step 701, an amount of the transaction may be deducted from a balance on the virtual payment device. In step 712, a determination is made as to whether there is any additional balance remaining on the virtual payment device after the amount of the transaction has been deducted. If not, the virtual payment device may be deleted in step 716. If there is a balance remaining in step 712, the balance may be stored in association with the virtual payment device in step 714 unless this would violate one or more other parameters. For instance, if the virtual payment device is expired (or expiring) the balance may only be stored until the expiration date and then the virtual payment device may be deleted.

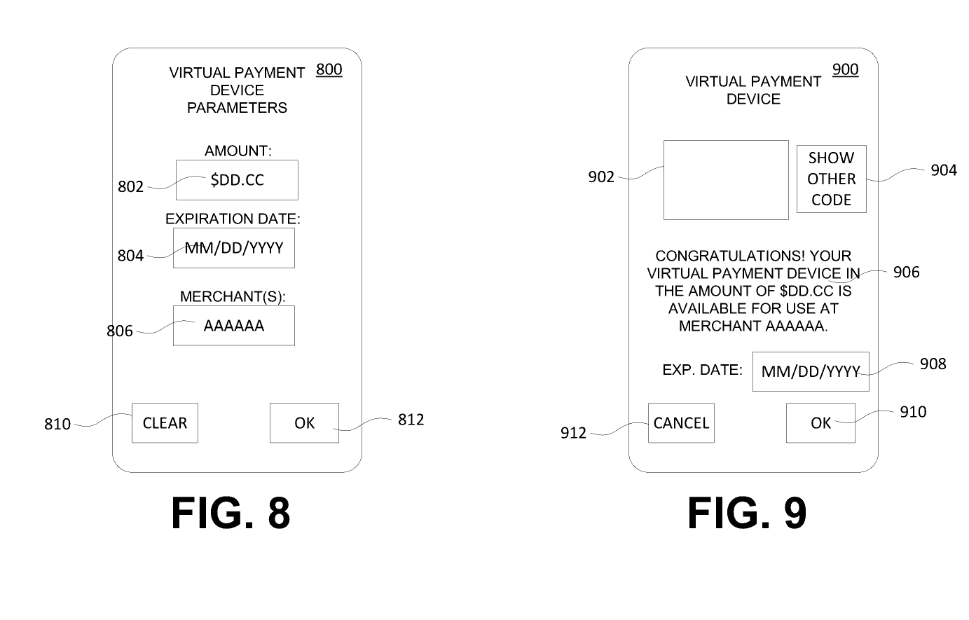

FIG. 8 illustrates one example user interface for inputting one or more virtual payment device parameters according to one or more aspects described herein. The interface 800 includes fields for inputting one or more virtual payment device parameters. For instance, interface 800 include field 802 in which an amount of the virtual payment device may be input. An expiration date of the virtual payment device may be input in field 804. The date may be directly inserted into field 804 by the user or, upon selection of field 804, a calendar interface may be displayed and the user may select a desired expiration date from the calendar.

In field 806, one or more merchants at which the virtual payment device may be used may be input by the user. In some examples, the user may directly input a name of a merchant. In other examples, the user may select a merchant name from, for example, a drop down list of available merchants. In some examples, multiple merchants may be selected (e.g., by holding the CTRL key while making multiple selections). Accordingly, the virtual payment device may be used at any of the selected merchants. In other examples, no merchants may be selected. If not particular merchants are selected, the virtual payment device may be used at any merchant having a point of sale system with capabilities for scanning the bar code or QR code of the virtual payment device.

Once the user has made the desired selections, the user may select “OK” option 812 and the virtual payment device may be generated. Alternatively, the user may select “CLEAR” option 810 and all inputs may be cleared or deleted.

FIG. 9 illustrates one example user interface 900 displaying a virtual payment device. The interface 900 includes code region 902. Code region may be an area in which either a bar code or QR code (or both, in some examples) may be displayed. For instance, code region 902 may include a first type of code (e.g., one of a bar code or QR code). The code may be scanned at a point of sale system in order to use the virtual payment device during a transaction at the merchant. However, if the merchant does not have the capability to scan the code in region 902, the user may elect to have the second type of code (e.g., the other of the bar code or QR code) displayed in region 902 by selecting “show other code” option 904. Option 904 may cause the first type of code to no longer be displayed and, in its place, to display the second type of code. In some example arrangements, both types of codes may be displayed simultaneously. In those arrangements, option 904 might not be included in the interface.

Interface 900 further includes field 906 in which information such as the amount of the virtual payment device and/or the merchants at which the device may be used is provided. Field 908 includes the expiration date of the virtual payment device. The user may select “OK” option 910 or “CANCEL” option 912 when finished using or viewing the virtual payment device.

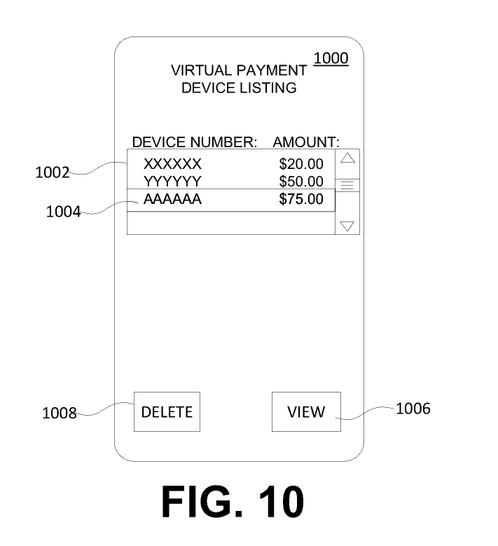

FIG. 10 illustrates one example interface listing available virtual payment devices for a particular user. Interface 1000 includes region 1002 in which all available virtual payment devices associated with a user may be identified. The list may include a scroll bar or other device for viewing virtual payment devices not visible within region 1002. Selection of one or more virtual payment devices may cause the selected device to be highlighted, as shown by 1004. The selected item, such as 1004, may then be viewed by selecting “VIEW” option 1006. Alternatively, the user may delete the highlighted virtual payment device by selecting “DELETE” option 1008. Selecting option 1008 may prompt display of an additional interface (not shown in FIG. 10) in which confirmation of the desire to delete the selected virtual payment device is requested.

Interfaces 800, 900 and 1000, shown in FIGS. 8, 9, and 10, respectively, are merely some example user interfaces that may be provided with the virtual payment device generation and processing system. More or additional information may be provided in one or more of the interfaces without departing from the invention. For instance, in FIG. 10, interface 1000 may also list an expiration date associated with each virtual payment device listed. Nothing in FIG. 8, 9, or 10 should be viewed as limiting available user interfaces to only those shown or to only the information provided in the interfaces shown.

The following constitutes one example of generating and using a virtual payment device according to one or more aspects described herein. The example is merely one example arrangement and is not intended to limit the virtual payment devices and associated systems, methods, and the like, described herein. Rather, various other example implementations may be used without departing from the invention.

In one example, a user may request to generate a virtual payment device. The request may be made via a user's mobile device, such as a smartphone, tablet, or the like. In some arrangements, the request may be made through an application running on the user's mobile device. The application may be associated with, received from, provided by, or the like, an entity such as a financial institution at which the user has one or more accounts. In some arrangements, the application may be a mobile banking application that includes an option to generate a virtual payment device having a scannable code, as described herein.

The request may be transmitted to a back end server, such as a virtual payment device generator. The system may then request authentication information from the user. For instance, an interface may be displayed on the user's mobile device requesting input of authentication information, such as a username and password, biometric data, or the like. If the authentication information input by the user matches pre-stored authentication information, the system may initiate generation of the virtual payment device and may request the user provide one or more parameters for the virtual payment device. For instance, the system may request the user identify an amount of the virtual payment device, an expiration date of the virtual payment device, and identify any limitations on merchants at which the virtual payment device may be used, as desired. In some examples, the expiration date may be a date after which the virtual payment device will no longer be valid, a date after which the virtual payment device will be automatically deleted from the system, or the like. In examples in which an amount of funds is deducted from the user account upon generating the virtual payment device, if the expiration date of the virtual payment device passes, in some examples, the virtual payment device may be deleted and any remaining funds on the virtual payment device (e.g., a balance remaining on the virtual payment device) may be restored to the account from which the funds were deducted.

The system may identify one or more accounts from which an amount of the virtual payment device may be withdrawn. The account may be automatically selected by the system (e.g., may automatically default to a particular type of account, may default to a user-selected default account, or the like), or the system may provide the user with a request to select an account. Once an account has been selected and any parameters have been received, the system may generate the virtual payment device. Generating the virtual payment device may include generating one or both of a scannable code, such as a bar code and/or QR code. In some examples, only one type of code may be displayed on the virtual payment device at a time. The virtual payment device may then include an option to display the other type of code, as desired. In some arrangements, both codes may be generated with the virtual payment device but only one code may be displayed at a time so a user may toggle between display of a first type of code and a second type of code. In other arrangements, both codes may be displayed simultaneously.

The system may then transmit the virtual payment device to the user (e.g., to the mobile device of the user). In some examples, the virtual payment device may be displayed via the application used by the user to request generation of the virtual payment device. Accordingly, the system may be used to generate a virtual payment device in real-time (or near real-time) such that it can be generated while the user is at the merchant and may be used as soon as it is transmitted to the user. Thus, the virtual payment device could be used, for example, in lieu of a debit card, credit card, or the like, in order to maintain the privacy and security of the numbers associated with those cards. For example, by using the virtual payment device in lieu of a debit card, the user would not need to show the debit card or enter a PIN number, which would reduce opportunities for people to obtain the card/PIN number and conduct transactions without authorization.

Additionally or alternatively, the virtual payment device may be transmitted via an email or SMS to the user. The virtual payment device itself may be transmitted or a link that may be selected to prompt display of the virtual payment device may be transmitted. In some examples, the system may transmit the virtual payment device to a primary or default email associated with the user's mobile device (e.g., the system may only transmit the virtual payment device to the primary email address of record). In such arrangements, a user may then forward the received email to one or more other email addresses (e.g., another email address of the user, an email address of another user to give the virtual payment device as a gift, or the like).

Once the virtual payment device has been received, the user may display the virtual payment device with the scannable code at a merchant and may scan the code at a point of sale system to use the virtual payment device as a method of payment. The transaction may then be processed using the virtual payment device as a method of payment, as discussed herein. If any balance is remaining on the virtual payment device after the transaction has been processed, that balance may be stored for future use. That is, a user may continue to use the virtual payment device until all remaining funds have been used, an expiration date passes, the virtual payment device is deleted, or the like.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A method, comprising:
receiving, by a virtual payment device generation and processing system including at least a virtual payment generator, a request to generate a virtual payment device;
retrieving, by virtual payment device generator and from one or more databases, user information associated with the request to generate the virtual payment device, the user information including an account of the user from which an amount of the virtual payment device will be withdrawn;
generating, by the virtual payment device generator, the virtual payment device, generating the virtual payment device including generating at least a first type of scannable code including at least the amount of the virtual payment device;
transmitting, from the virtual payment device generator to a mobile device of the user, the virtual payment device including the at least the first type of scannable code.

2. The method of claim 1, wherein the first type of scannable code is at least one of a bar code and a quick response (QR) code.

3. The method of claim 2, wherein the virtual payment device includes a region for display of a scannable code and an option to display a second type of scannable code different from the first type of scannable code.

4. The method of claim 3, further including:
receiving a selection, by the user of the mobile device, the option to display the second type of scannable code; and
in response to selection of the option to display the second type of scannable code, removing the first type of scannable code from the region for display of the scannable code and displaying, in the region for display of the scannable code, a scannable code of the second type.

5. The method of claim 1, wherein the virtual payment device is generated in real time and further including:
scanning, by a point of sale system, the first type of scannable code on the virtual payment device as payment for a purchase.

6. The method of claim 5, further including:
in response to scanning, by the point of sale system, the first type of scannable code as payment for a purchase, transmitting, by the point of sale system, a request for authorization to process the transaction; and
responsive to receiving authorization to process the transaction, deducting, by the virtual payment device generation and processing system, an amount of the transaction from a balance of the virtual payment device.

7. The method of claim 6, further including:
determining, by the virtual payment device generation and processing system, whether a balance greater than zero remains on the virtual payment device after deducting the amount of the transaction from the balance of the virtual payment device; and
responsive to determining that the balance is greater than zero, storing the remaining balance.

8. The method of claim 6, further including:
determining, by the virtual payment device generation and processing system, whether a balance greater than zero remains on the virtual payment device after deducting the amount of the transaction from the balance of the virtual payment device; and
responsive to determining that a balance greater than zero does not remain on the virtual payment device, deleting the virtual payment device.

9. The method of claim 1, further including:
transmitting, by the virtual payment device generation and processing system and to the mobile device, a request for authentication information of the user prior to generating the virtual payment device;
receiving, by the virtual payment device generation and processing system and from the mobile device, authentication information of the user;
determining whether the received authentication information matches pre-stored authentication information of the user; and
responsive to determining that the received authentication information matches the pre-stored authentication information, generating the virtual payment device.

10. The method of claim 9, wherein the authentication information includes at least one of a username, password and biometric data.

11. The method of claim 1, further including:
receiving, prior to generating the virtual payment device, one or more parameters associated with the virtual payment device; and
wherein the first type of scannable code includes data associated with the received parameters.

12. The method of claim 11, wherein the received parameters include at least one of: an amount of the virtual payment device, an expiration date of the virtual payment device, and at least one merchant at which the virtual payment device may be used.

13. An apparatus, comprising:
at least one processor; and
a memory storing instructions that when executed by the at least one processor cause the apparatus to:
receive, a request to generate a virtual payment device;
retrieve, from one or more databases, user information associated with the request to generate the virtual payment device, the user information including an account of the user from which an amount of the virtual payment device will be withdrawn;
generate, by a virtual payment device generator, the virtual payment device, generating the virtual payment device including generating at least a first type of scannable code including at least the amount of the virtual payment device;
transmit, from the virtual payment device generator to a mobile device of the user, the virtual payment device including the at least the first type of scannable code.

14. The apparatus of claim 13, wherein the first type of scannable code is at least one of a bar code and a quick response (QR) code and wherein the virtual payment device includes a region for display of a scannable code and an option to display a second type of scannable code different from the first type of scannable code.

15. The apparatus of claim 14, further including instructions that, when executed, cause the apparatus to:
receive a selection of the option to display the second type of scannable code; and
in response to selection of the option to display the second type of scannable code, remove the first type of scannable code from the region for display of the scannable code and display, in the region for display of the scannable code, a scannable code of the second type.

16. The apparatus of claim 13, further including instructions that, when executed, cause the apparatus to:
scan, by a point of sale system, the first type of scannable code on the virtual payment device as payment for a purchase;
in response to scanning, by the point of sale system, the first type of scannable code as payment for a purchase, receive, from the point of sale system, a request for authorization to process the transaction; and
responsive to receiving authorization to process the transaction, deduct an amount of the transaction from a balance of the virtual payment device.

17. The apparatus of claim 13, further including instructions that, when executed, cause the apparatus to:
receive, prior to generating the virtual payment device, one or more parameters associated with the virtual payment device, wherein the first type of scannable code includes data associated with the received parameters, and
wherein the received parameters include at least one of: an amount of the virtual payment device, an expiration date of the virtual payment device, and at least one merchant at which the virtual payment device may be used.

18. One or more non-transitory computer-readable media having instructions stored thereon that when executed by one or more computers cause the one or more computers to:
receive, a request to generate a virtual payment device;
retrieve, from one or more databases, user information associated with the request to generate the virtual payment device, the user information including an account of the user from which an amount of the virtual payment device will be withdrawn;
generate, by a virtual payment device generator, the virtual payment device, generating the virtual payment device including generating at least a first type of scannable code including at least the amount of the virtual payment device;
transmit, from the virtual payment device generator to a mobile device of the user, the virtual payment device including the at least the first type of scannable code.

19. The one or more non-transitory computer-readable media of claim 18, wherein the first type of scannable code is at least one of a bar code and a quick response (QR) code and wherein the virtual payment device includes a region for display of a scannable code and an option to display a second type of scannable code different from the first type of scannable code.

20. The one or more non-transitory computer-readable media of claim 18, further including instructions that, when executed, cause the one or more computers to:
receive, prior to generating the virtual payment device, one or more parameters associated with the virtual payment device, wherein the first type of scannable code includes data associated with the received parameters, and
wherein the received parameters include at least one of: an amount of the virtual payment device, an expiration date of the virtual payment device, and at least one merchant at which the virtual payment device may be used.
